(19) United States
(12) Patent Application Publication
(10) Pub. No.: US 2009/0204812 A1
(43) Pub. Date: Aug. 13, 2009

(54) MEDIA PROCESSING

(76) Inventors: Todd M. Baker, Los Altos, CA (US); Danelle Tai-Ling Au, Los Altos, CA (US); Ashutosh Malegaonkar, Milpitas, CA (US); Mohammed Taher Shaikh, Fremont, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/030,596

(22) Filed: Feb. 13, 2008

(51) Int. Cl. H04L 29/00

(52) U.S. Cl. 713/160

(57) ABSTRACT

In an example embodiment, an apparatus comprising a communication interface configured to be in data communication with another device, and processing logic that is operably coupled to the communication interface. The processing logic is operable to process a packet received via the communication interface, the packet comprising a header and a payload. The processing logic is configured to acquire information about the contents of the payload from the header. For example, the processing logic can determine from the header of the packet whether the payload contains sensitive data; contains analytic, video, and/or audio data; and/or whether the payload is encrypted.

### TECHNICAL FIELD

This disclosure is generally related to data communications such as packet processing of a media stream.

### BACKGROUND

Physical Security over an Internet Protocol (IP) Network is a very large emerging market. Even with this emerging market there has been no clear leadership in the direction for ensuring the media traffic remains secure. Most products today operate in an insecure manner where their signals can be intercepted, and their media captured and replayed. Those that do implement security require HTTP(s) (Hyper Text Transfer Protocols) or proprietary methodologies for transport which require modification to decoders and often place additional processing loads on infrastructure devices, rather than on decoding devices.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a communication interface configured to be in data communication with another device and processing logic operably coupled to the communication interface. The processing logic is configured to process a packet received via the communication interface, the packet comprising a header and a payload. The processing logic is configured to acquire information about the contents of the payload from the header.

In accordance with an example embodiment, there is described herein a method, comprising receiving a packet, the packet comprising a header and a payload. The method further comprises determining whether the payload contains sensitive data from data in the header. The method also comprises determining analytics event data from data in the header. The method still further comprises determining whether the payload contains video data from data in the header, determining whether the payload contains audio data from data in the header and determining whether the payload is encrypted from data in the header.

### BRIEF DESCRIPTION OF THE DRAWINGS

The accompanying drawings incorporated herein and forming a part of the specification illustrate the examples embodiments.

FIG. 1 illustrates an example Real Time Protocol packet format in accordance with an example embodiment.

FIG. 2 illustrates an example format for a Real Time Protocol header extension in accordance with an example embodiment.

FIG. 3 illustrates a data format for data inserted into a Real Time Protocol header extension in accordance with an example embodiment.

FIG. 4 illustrates an example Secure Real Time Protocol packet format in accordance with an example embodiment.

FIG. 5 illustrates an example apparatus configured in accordance with an example embodiment.

FIG. 6 illustrates an example routing apparatus configured in accordance with an example embodiment.

FIG. 7 illustrates a computer system for implementing an example embodiment.

FIG. 8 illustrates a methodology in accordance with an example embodiment.

FIG. 9 illustrates a methodology with potential packet processing options.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements.

Described herein in an example embodiment is a technique for providing additional information in the header of a data frame. The example embodiments illustrated herein are suitable for implementation with (Request for Comments) RFC-3550 (July 2003) Real Time Protocol (RTP) header extension. The header extension described herein enables a device to determine the content of a data frame by looking at the header, without revealing the content. This can enable media handling of encrypted media, unencrypted media or media employing both encrypted and unencrypted media.

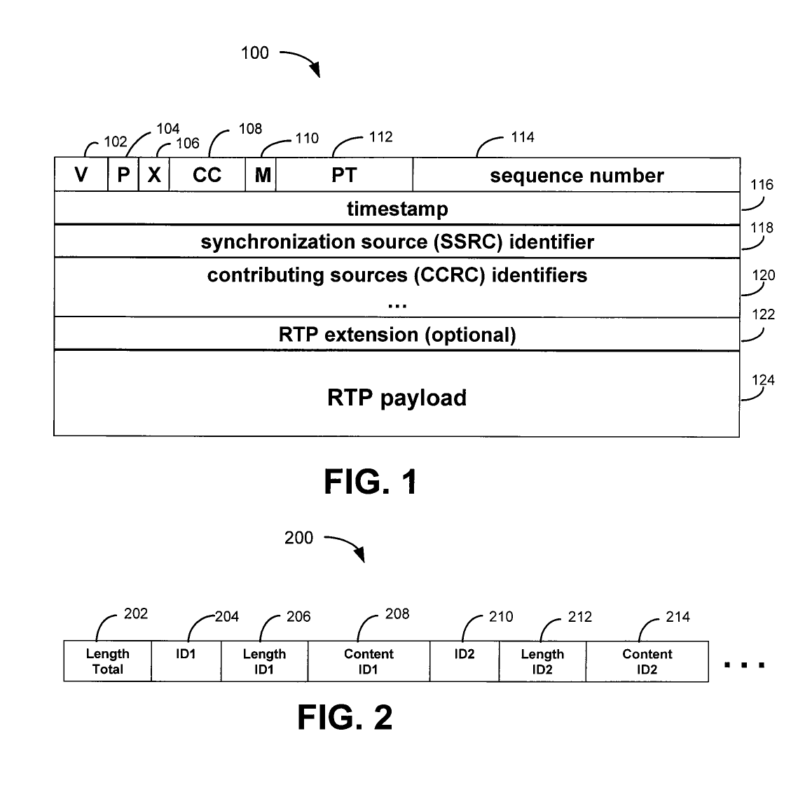

FIG. 1 illustrates an example Real Time Protocol packet format 100 in accordance with an example embodiment. The packet comprises a version (V) field 102 that is 2 bits. This field identifies the version of RTP. For example the version defined by RFC 3350 (July 2003) is two (2). The value 1 is used by the first draft version of RTP.

The padding (P) field 104 is 1 bit. If the padding bit is set, the packet contains one or more additional padding octets at the end which are not part of the payload. The last octet of the padding contains a count of how many padding octets should be ignored, including itself. Padding may be employed by some encryption algorithms with fixed block sizes or for carrying several RTP packets in a lower-layer protocol data unit.

The extension (X) field 106 is 1 bit. If the extension bit is set, the fixed header is followed by a header extension. The format of the header extension is defined in Section 5.3.1 of RFC 3550. A header extension in accordance with an example embodiment will be illustrated in FIG. 2.

The CSRC count (CC) field 108 is 4 bits. The CSRC count contains the number of CSRC identifiers that follow the fixed header.

The marker (M) field 110 is 1 bit. The interpretation of the marker is defined by a profile. It is intended to allow significant events such as frame boundaries to be marked in the packet stream. A profile may define additional marker bits or specify that there is no marker bit by changing the number of bits in the payload type (PT) field 114 described herein infra.

The payload type (PT) field 112 is 7 bits. This field identifies the format of the RTP payload and determines its interpretation by the application. A profile may specify a default static mapping of payload type codes to payload formats. Additional payload type codes may be defined dynamically through non-RTP means. An RTP source may change the payload type during a session. A receiver ignores packets with payload types that it does not understand.

The sequence number field 114 is 16 bits. The sequence number increments by one for each RTP data packet sent, and may be used by the receiver to detect packet loss and to restore packet sequence. The initial value of the sequence number should be random (unpredictable) to make known-plaintext attacks on encryption more difficult.

The timestamp field 116 is 32 bits. The timestamp field 116 reflects the sampling instant of the first octet in the RTP data packet. The sampling instant is derived from a clock that increments monotonically and linearly in time to allow synchronization and jitter calculations. The resolution of the clock is sufficient for the desired synchronization accuracy and for measuring packet arrival jitter (for example, one tick per video frame is typically not sufficient). The clock frequency is dependent on the format of data carried as payload and is specified statically in the profile or payload format specification that defines the format, or may be specified dynamically for payload formats defined through non-RTP means. If RTP packets are generated periodically, the nominal sampling instant as determined from the sampling clock is to be used, not a reading of the system clock. As an example, for fixed-rate audio the timestamp clock would likely increment by one for each sampling period. If an audio application reads blocks covering 160 sampling periods from the input device, the timestamp would be increased by 160 for each such block, regardless of whether the block is transmitted in a packet or dropped as silent.

The synchronization source (SSRC) identifier field 118 is 32 bits. The SSRC field 118 identifies the synchronization source. This identifier should be chosen randomly, with the intent that no two synchronization sources within the same RTP session will have the same SSRC identifier.

The contributing sources (CCRC) identifiers field 120 is a list of 0 to 15 items, 32 bits each. The CSRC list identifies the contributing sources for the payload contained in this packet. The number of identifiers is given by the CC field 108. If there are more than 15 contributing sources, only 15 can be identified. For example, for audio packets, the SSRC identifiers of all sources that were mixed together to create a packet are listed.

The RTP header extension 122 is provided to allow individual implementations to experiment with new payload-format-independent functions that require additional information to be carried in the RTP data packet header. This mechanism is designed so that the header extension may be ignored by other interoperating implementations that have not been extended.

If the X field (bit) 106 in the RTP header is one, this indicates a variable-length header extension 122 is appended to the RTP header, following the CSRC list if present.

The RTP payload 124 contains the data transported by RTP in the packet. For example, the data in RTP payload 124 may contain audio samples or compressed video data.

In accordance with an example embodiment, the X field (bit) 106 is set to indicate a variable length RTP header extension 122 is appended to the RTP header. As will be described herein, RTP header extension 122 suitably comprises data for one or more of

a Data Sensitivity Restrictions indication to denote that the payload 124 of packet 100 contains sensitive data;

an analytics event indication to associate specific analytics (audio, video or other) events with payload 124;

data indicating whether the payload 124 contains video data and a Video Frame Type indication with options for identifying Intra Frames (“I Frames”), Predictive Frames (“P frames”) and Bidirectional Frames (“B Frames”);

data indicating whether payload 124 contains audio data;

data indicating whether payload 124 is encrypted; and

a content field comprising additional information appropriate for payload 124; data in the content field can be in a predefined bitwise format and can include analytics type definition, name information for an analytics header indication and/or encryption data such as encryption type and/or a key identifier for an encrypted payload.

The packet format described herein enables network components to intelligently process the packets. Policies can be applied to a wide variety of components to enhance physical security. For example, network components can be configured to block sensitive traffic, allow all traffic, allow only sensitive traffic when encrypted, etc., which the network components can determine from the header without revealing the contents of payload 124.

By employing the packet format described herein, infrastructure components do not need encryption capabilities. The packet format described herein also enables post processing of data frames without the requirement for decryption. For example, as a digital video recorder makes decisions regarding frame pruning, the recorder can simply identify the “I” frames (to prune the video without re-encoding) from the header information without having to decrypt the stream. With the inclusion of event identifiers into header extension 122, a digital video recorder can perform offline pruning of data for only relevant events.

In an example embodiment, endpoints are responsible for decryption of the data contained in payload 124. Infrastructure components between the endpoints do not decrypt the packets, which can result in faster processing by the infrastructure components.

FIG. 2 illustrates an example format for a Real Time Protocol header extension 200 in accordance with an example embodiment. Format 200 is suitable for implementing header extension 122 described in FIG. 1. The length total field 202 contains data indicating the total length of header extension 200. Each header extension comprises three fields, an identifier field, a length field and a content field. In the illustrated example, the first extension identifier is ID1 204, the length of the first extension is stored in Length ID1 206 and the contents of the first extension are stored in Content ID1 208. The second extension identifier is ID2 210, the length of the second extension is stored in Length ID2 212 and the second extension is stored in Content ID2 214.

In accordance with an example embodiment, one or more extensions (for example, the first extension comprising ID1 204, Length ID1 206, Content ID1 208 and/or the second extension comprising ID2 210, Length ID2 212, Content ID2 214) are employed for providing information about what the packet contains without revealing the packet contents. For example, header extension 200 may suitably comprise data to indicate that the payload of the packet 100 contains sensitive data. As another example, header extension 200 may suitably comprise analytics event indication to associate specific analytics (audio, video or other) events with the payload. As another example, header extension 200 may suitably comprise data indicating whether the packet's payload contains video data and a Video Frame Type indication with options for identifying I Frames, P frames and B Frames. Yet another example, header extension 200 may suitably comprise data indicating whether the packet's payload contains audio data. As another example, header extension 200 suitably comprises data indicating whether payload 124 is encrypted. Optionally, packet header extension 200 may suitably comprise a content field containing additional information appropriate for the packet's payload. For example, data in the content field can be in a predefined bitwise format and can include analytics type definition, name information for an analytics header indication and/or encryption data such as encryption type and/or a key identifier for an encrypted payload.

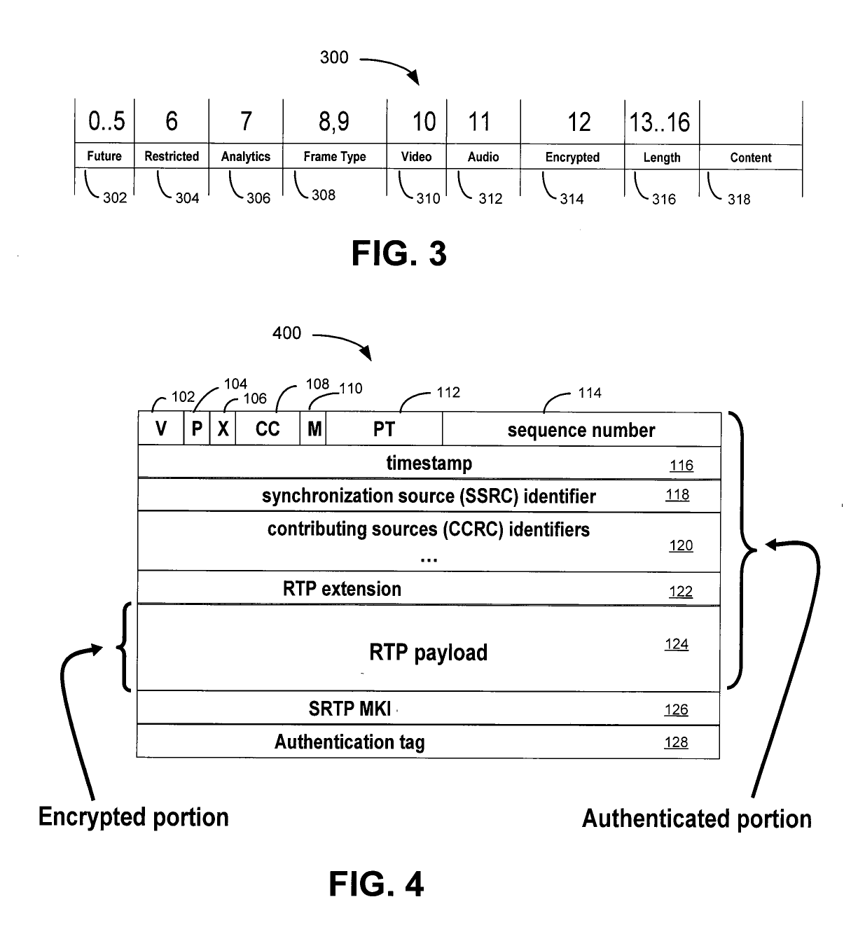

Referring to FIG. 3, there is illustrated a data format 300 for data inserted into a Real Time Protocol header extension in accordance with an example embodiment. Data format 300 is suitable for content ID1 field 208 and/or content ID2 field 214 illustrated in FIG. 2. The field (or bit) widths and order of fields illustrate an example embodiment and should not be construed as limited to the illustrated embodiment. Field widths may be varied as appropriate for an application implementing an example embodiment. In particular embodiments, the order of the fields may be different; for example, some fields may not be present, additional fields may be employed and/or a different ordering of the fields may be employed.

In an example embodiment, a default value of 0 is employed as a negative indication. Future field (bits 0 through 5) 302 is reserved for future expansion of additional subtypes in the ID header default. Restricted bit (bit 6) 304 indicates that the payload of the packet contains sensitive information. Analytics bit (bit 7) 306 indicates an event within the associated audio/video channel has been occurring along with the payload of the packet.

Frame type (bits 8 and 9) 308 is used to describe the type of video frame contained in the packet. In an example embodiment, frame type 308 is only used when Video (bit 10) 310 is set. For example, a value of 00 in frame type 308 indicates an unknown frame type or non-video source. A value of 01 in frame type 308 indicates the packet payload is an Intra (I) frame. A value of 10 in frame type 308 indicates the packet payload is a Predicted (P) frame. A value of 11 in frame type 308 indicates the packet payload is a bidirectional (B) frame.

Video (bit 10) bit 310 is used to indicate the presence of video data in the packet payload. Audio (bit 11) bit 312 indicates the presence of audio data in the packet payload. Encrypted (bit 12) bit 314 indicts that the payload is encrypted. Optionally, content (bits 17 and higher) field 318 may indicate the method of encryption or other pertinent information such as a key identifier. Length (bits 13 through 16) field 316 indicates the number of bytes present in the subsequent content field 318. In the illustrated example, length field 318 is four bits, thus the length of content field 318 can be between 0 and 15 bytes. Content field 318 can be employed to provide any additional information.

FIG. 4 illustrates an example Secure Real Time Protocol (SRTP) packet format 400 in accordance with an example embodiment. Packet 400 suitably comprises the same fields as packet format 100 illustrated in FIG. 1, and also has two additional fields. The packet format for a SRTP packet is defined in RFC 3711. The SRTP MKI (Master Key Identifier) field 126 has a configurable length. The MKI is defined, signaled, and used by key management. The STRP MKI identifies the master key from which the session key(s) were derived that authenticate and/or encrypt the particular packet.

The Authentication tag 128 is a configurable length field. The authentication tag 128 is used to carry message authentication data. The Authenticated Portion of an SRTP packet consists of the RTP header (comprising V 102, P 104, X 106, CC 108, M 110, PT 112, sequence number 114, timestamp 116, SSRC identifier 118, CCRC identifiers 120 and RTP extension 122) followed by the Encrypted Portion (payload 124) of the SRTP packet. Thus, if both encryption and authentication are applied, encryption is applied before authentication on the sender side and conversely on the receiver side. The authentication tag 128 provides authentication of the RTP header and payload 124, and indirectly provides replay protection by authenticating the sequence number 114.

The properties and capabilities described herein for a header extension to an RTP packet are also applicable to a SRTP packet. Thus, as used herein, RTP packet or RTP compatible packet also includes an SRTP packet or SRTP compatible packet.

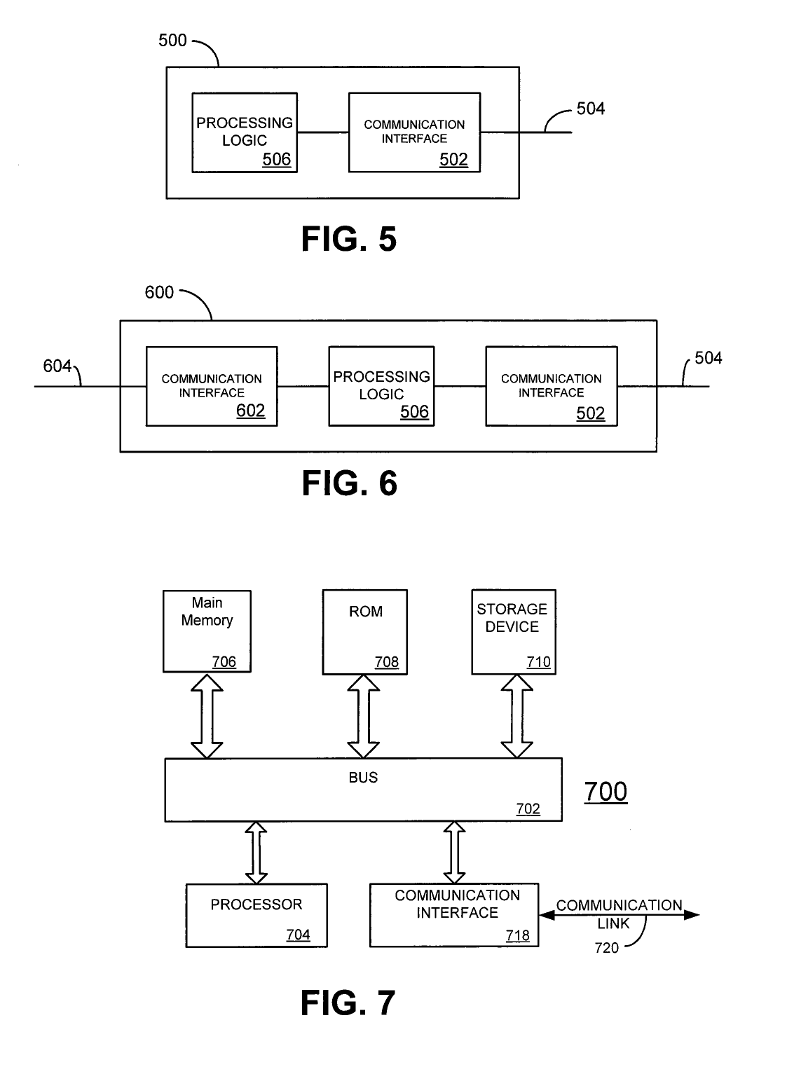

FIG. 5 illustrates an example apparatus 500 configured in accordance with an example embodiment. Apparatus 500 comprises a communication interface 502 configured to send and/or receive data. Communication interface 502 provides a two-way data communication via communication link 504. For example, communication interface 502 may be a local area network (LAN) card to provide a data communication connection to a compatible LAN. As another example, communication interface 502 may be an integrated services digital network (ISDN) card or a modem to provide a data communication connection to a corresponding type of telephone line. Wireless links may also be implemented. In any such implementation, communication interface 502 sends and receives electrical, electromagnetic, or optical signals that carry digital data streams representing various types of information.

Processing logic 506 processes data received via communication interface 502. “Logic,” as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

In an example embodiment, processing logic 506 acquires information about the content of packets received on link 504 by communication interface 502 by examining the header of a packet. For RTP or SRTP packets, processing logic 506 acquires the information from header extensions as described in example embodiments disclosed herein. For example, processing logic 506 can determine whether the payload of a packet contains sensitive data. As another example, header extension 200 may suitably comprise analytics event indication to associate specific analytics (audio, video or other) events with the payload.

As another example, processing logic 506 can determine whether the packet's payload contains video data and a Video Frame Type indication with options for identifying I Frames, P frames and B Frames. For pruning a video stream, processing logic can identify the I Frames, P Frames and B Frames for a Group of Packets and can retain the I Frames while pruning the P Frames and B Frames.

As yet another example, processing logic 506 can determine whether the packet's payload contains audio data. Still another example, processing logic 506 can determine whether the packet's payload is encrypted. Optionally, processing logic 506 can determine additional information appropriate for the packet's payload. For example, processing logic 506 can ascertain analytics type definition, name information for an analytics header indication and/or encryption data such as encryption type and/or a key identifier for an encrypted payload.

Processing logic 506 can use the information obtained from a packet's header for determining how to process a packet. For example, if a packet header indicates the packet contains sensitive data, processing logic 506 may block the packet from an unsecured link. Processing logic 506 can use analytic event indication data to associate specific analytics (audio, video or other) events with the packet's payload. If the packet payload contains video data, processing logic 506 can determine from the header whether the packet can be pruned. For example, I frames should not be pruned from a video stream; however, P frames and B frames can be pruned.

FIG. 6 illustrates an example routing 600 apparatus configured in accordance with an example embodiment. Apparatus 600 comprises a second communication interface 602 coupled to a second communication link 604. In an example embodiment, processing logic 506 routes packets between communication links 504 and 604. Processing logic 506 can employ the data contained in the packet header, e.g. in an extended RTP header, to determine whether a packet.

In an example embodiment, link 504 is coupled to a secure network while link 604 is coupled to an insecure network. Processing logic 506 can examine packet headers of packets arriving from link 504. If a header indicates the packet contains sensitive data, processing logic 506 can block the packet from being forwarded on link 604. In an alternative embodiment, processing logic 506 can be configured to allow a packet that has sensitive data to be routed from communication interface 502 to communication interface 602 if the header further indicates the packet's contents are encrypted. In another embodiment, processing logic 506 may encrypt packets from communication interface 502 containing sensitive data before forwarding to communication interface 602.

In an example embodiment, communication link 604 is a low speed connection compared to link 504. Thus, it may be desirable to compress packets destined for link 504. However, re-compressing packets that are already compressed and/or encrypted may waste valuable processing time. Thus, processing logic 506 can examine a frame's header, such as by using techniques disclosed herein, before attempting to compress or perform any other packet processing, and process the packet accordingly.

FIG. 7 is a block diagram that illustrates a computer system 700 upon which an example embodiment may be implemented. Computer system 700 includes a bus 702 or other communication mechanism for communicating information and a processor 704 coupled with bus 702 for processing information. Computer system 700 also includes a main memory 706, such as random access memory (RAM) or other dynamic storage device coupled to bus 702 for storing information and instructions to be executed by processor 704. Main memory 706 also may be used for storing a temporary variable or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

An aspect of the example embodiment is related to the use of computer system 700 for media processing. According to an example embodiment, media processing is provided by computer system 700 in response to processor 704 executing one or more sequences of one or more instructions contained in main memory 706. Such instructions may be read into main memory 706 from another computer-readable medium, such as storage device 710. Execution of the sequence of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media, volatile media, and transmission media. Non-volatile media include, for example, optical or magnetic disks, such as storage device 710. Volatile media include dynamic memory such as main memory 706. Transmission media include coaxial cables, copper wire and fiber optics, including the wires that comprise bus 702. Transmission media can also take the form of acoustic or light waves such as those generated during radio frequency (RF) and infrared (IR) data communications. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 704 for execution. For example, the instructions may initially be borne on a magnetic disk of a remote computer. The remote computer can load the instructions into its dynamic memory and send the instructions over a telephone line using a modem. A modern local to computer system 700 can receive the data on the telephone line and use an infrared transmitter to convert the data to an infrared signal. An infrared detector coupled to bus 702 can receive the data carried in the infrared signal and place the data on bus 702. Bus 702 carries the data to main memory 706 from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a communication link 720. Communication link 720 is suitably any wired or wireless link available to communicate with another device. For example, communication interface 718 may be a local area network (LAN) card to provide a data communication connection to a compatible LAN. As another example, communication interface 718 may be an integrated services digital network (ISDN) card or a modem to provide a data communication connection to a corresponding type of telephone line. Wireless links may also be implemented. In any such implementation, communication interface 718 sends and receives electrical, electromagnetic, or optical signals that carry digital data streams representing various types of information.

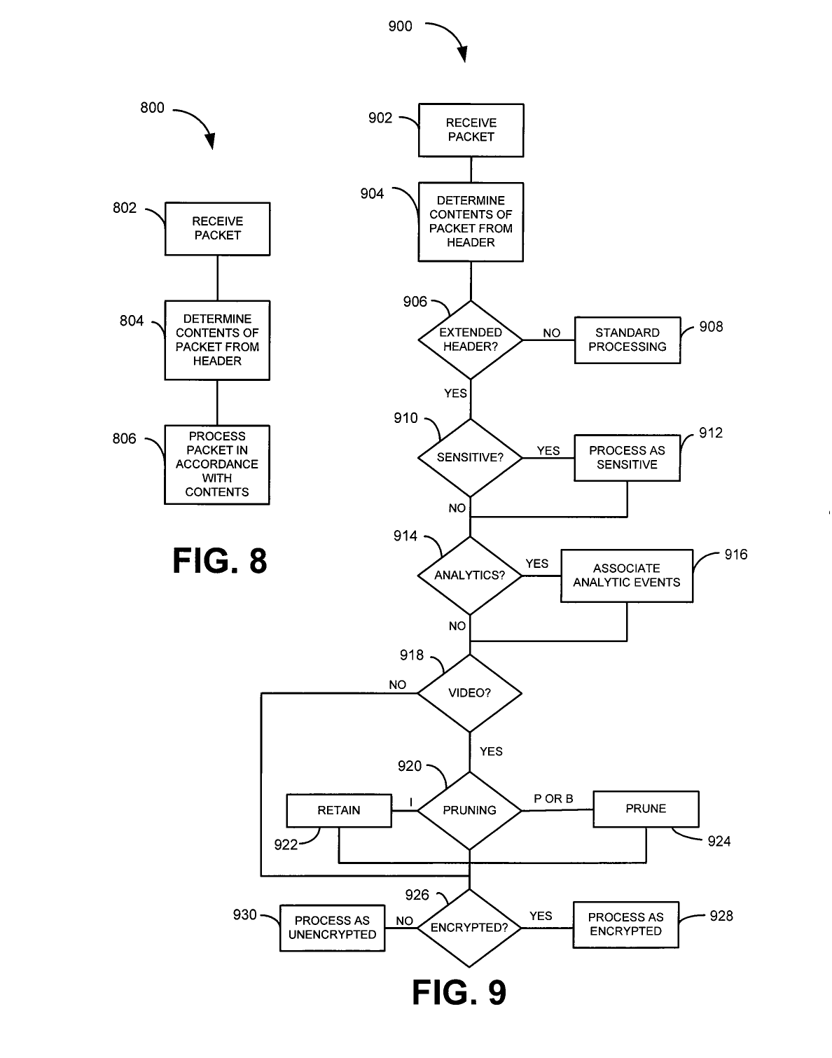

In view of the foregoing structural and functional features described above, a methodology in accordance with an example embodiment will be better appreciated with reference to FIGS. 8 and 9. While, for purposes of simplicity of explanation, the methodologies of FIGS. 8 and 9 are shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect the example embodiment. The methodologies described herein are suitably adapted to be implemented in hardware, software, or a combination thereof.

FIG. 8 illustrates a methodology 800 in accordance with an example embodiment. At 802 a packet is received. The packet has a header and a payload. The header comprises protocol information, such as for example an RTP header. The payload comprises the data portion of the packet. In an example embodiment, the packet is formatted as described herein.

At 804, the contents of the packet are determined from the header. For example, if the header is an RTP header, the extended bit (see X field 106 in FIG. 1) in an RTP header can be checked to determine if the header contains a header extension. If the extended bit indicates a header extension, information about the payload contents can be acquired without actually deciphering the payload contents using the techniques described herein.

At 806, the packet is processed in accordance with the contents of the payload as determined from the packet header. For example, if the header indicates the payload contain sensitive data, the packet can be processed to insure the data does not leave a secure portion of the network. If the header contains analytics data, the processing can include associating the appropriate analytic events with the packet. If the header indicates the payload contains video data, which may also indicate the frame type, the processing may include pruning P frame or B frames while retaining I frames. The header can indicate the frame contains audio data, which can be processed accordingly. If the header indicates that the frame is compressed or encrypted, the frame can be processed accordingly.

FIG. 9 illustrates a methodology 900 with potential packet processing options. At 902 a packet is received. The packet has a header and a payload. The header comprises protocol information, such as for example an RTP header. The payload comprises the data portion of the packet. In an example embodiment, the packet is formatted as described herein.

At 904, the contents of the packet are determined from the header. For example, if the header is an RTP header, the extended bit (see X field 106 in FIG. 1) in an RTP header can be checked to determine if the header contains a header extension. If the extended bit indicates a header extension, information about the payload contents can be acquired about the payload contents without actually deciphering the payload contents using the techniques described herein. For example, a header extension can be employed for providing information about the contents of the frame.

At 906, if the header does not have an extended header (NO), then the frame is processed as a standard frame at 908. If at 906 it is determined that the frame contains a header extension (YES), at 910 a determination is made from the header contents whether the frame contains sensitive data. If the frame contains sensitive data (YES), at 912 the frame is processed as containing sensitive data. For example, the frame may be blocked from unsecured network segments or unsecured communications. If the frame does not contain sensitive data (NO) then it is not processed as containing sensitive data.

At 914 a determination is made from data contained in the header whether the frame contains analytics data. If the frame does contain analytics data (YES), at 916 analytics events are associated with the frame; otherwise (NO) analytics events are not associated with the frame.

At 918 a determination is made whether the frame contains video data. If the frame does contain video data (YES) additional processing, such as pruning at 920, can be performed. If at 920 the video stream is being pruned, the type of frame is determined. If the frame type is an I frame, the frame is retained at 922; if the frame type is a P frame or B frame, the frame is pruned at 924. If at 918 a determination is made the frame does not contain video data (NO), video processing is not performed.

At 926 a determination is made whether the frame contains encrypted data. Of the frame contains encrypted data (YES), the frame is processed as an encrypted frame at 928. For example, if compression is being performed, the frame may not be compressed because the frame may not compress well after encryption. If at 910 a determination was made that the frame contained sensitive data, the frame may be allowed to be forwarded on an unsecured communication link if it is encrypted. A decision on whether to forward the frame onto an unsecured communication link may be further include verifying the frame was encrypted by a sufficiently secure method. For example, using the RTP extension header described in FIG. 3, the type of encryption may be included in the content field 318. Alternatively, content field 318 (FIG. 3) may include data indicating the appropriate session key for the frame. If at 926 a determination is made that the frame is unencrypted (NO), at 930 the frame is processed unencrypted.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims, interpreted in accordance with the breadth to which they are fairly, legally and equitably entitled.

1. An apparatus, comprising:
a communication interface configured to be in data communication with another device; and
processing logic operably coupled to the communication interface;
wherein the processing logic is configured to process a packet received via the communication interface, the packet comprising a header and a payload; and
wherein the processing logic is configured to acquire media processing information about the contents of the payload from the header.

2. The apparatus according to claim 1, wherein the packet is a real time protocol compatible packet.

3. The apparatus according to claim 2, wherein the media processing information about the contents of the payload is acquired from an extension within the header.

4. The apparatus according to claim 1, wherein the processing logic is configured to determine whether the packet payload contains sensitive data from data acquired from the header.

5. The apparatus according to claim 1, wherein the processing logic is configured to determine whether the packet payload contains analytics event data from data acquired from the header.

6. The apparatus according to claim 5, wherein the processing logic is configured to associate an analytics event with the packet.

7. The apparatus according to claim 1, wherein the processing logic is configured to determine whether the packet payload contains video data from data acquired from the header.

8. The apparatus according to claim 7, wherein the processing logic is configured to determine whether the packet payload is a Inter Frame, Predictive Frame or a Bidirectional Frame from data acquired from the header.

9. The apparatus according to claim 8, wherein the processing logic is configured to receive a group of packets comprising an Inter Frame, a Predictive Frame and a Bidirectional frame;
wherein the processing logic is further configured to prune Predictive Frame and Bidirectional frame from the group of packets and retain the Inter Frame.

10. The apparatus according to claim 1, wherein the processing logic is configured to determine whether the packet payload contains audio data from data acquired from the header.

11. The apparatus according to claim 1, wherein the processing logic is configured to determine whether the packet payload is encrypted data acquired from the header.

12. The apparatus according to claim 11, wherein the processing logic is configured to determine session key data from data acquired from the header.

13. The apparatus according to claim 1, wherein the processing logic is configured to route packets received by the communication interface, the processing logic is further configured to block the packet from being routed onto an insecure network responsive to the header containing data indicating that the packet has sensitive data.

14. The apparatus according to claim 1, wherein the processing logic is configured to route packets received by the communication interface, the processing logic is further configured to block the packet from being routed onto an insecure network responsive to the header containing data indicating that the packet has sensitive data and the header containing data indicating that the payload is unencrypted.

15. The apparatus according to claim 1, wherein the processing logic is configured to route packets received by the communication interface, the processing logic is further configured to allow the packet to be routed onto an insecure network responsive to the header containing data indicating that the packet has sensitive data and the header containing data indicating that the payload is encrypted.

16. An apparatus, comprising:
means for receiving a packet, the packet comprising a header and a payload;
means for determining from the header whether the payload contains sensitive data;
means for determining from the header analytics event data;
means for determining from the header whether the payload contains video data;
means for determining from the header whether the payload contains audio data; and
means for determining from the header whether the payload is encrypted.

17. The apparatus according to claim 16, wherein the packet is a real time protocol compatible packet.

18. A method, comprising:
receiving a packet, the packet comprising a header and a payload;
determining whether the payload contains sensitive data from data in the header;
determining analytics event data from data in the header;
determining whether the payload contains video data from data in the header;
determining whether the payload contains audio data from data in the header;
determining whether the payload is encrypted from data in the header; and
forwarding the packet without compressing the packet responsive to determining from the data in the header that the payload is encrypted.

19. The method according to claim 18, further comprising:
determining whether video data in the payload contains an Intra Frame from data in the header;
determining whether the video data in the payload contains a Predictive Frame from data in the header; and
determining whether the video data in the payload contains a Bidirectional Frame from data in the header.

20. The method according to claim 18, further comprising:
blocking a frame from being forwarded from a secure link to an insecure link responsive to determining from data in the header that the payload contains sensitive data.
